(19) United States
(12) Patent Application Publication
(10) Pub. No.: US 2004/0194630 A1
(43) Pub. Date: Oct. 7, 2004

(54) Beverage with storage-stable dietary fiber additive

(76) Inventors: Eberhard Stoppok, Braunschweig (DE); Martin Walter, Bortfeld (DE); Dieter Wullbrandt, Gross Denkte (DE)

Correspondence Address: SALTER & MICHAELSON, THE HERITAGE BUILDING, 321 SOUTH MAIN STREET, PROVIDENCE, RI, 029037128

(21) Appl. No.: 10/487,562

(22) PCT Filed: Aug. 29, 2002
(86) PCT No.: PCT/EP02/09632

(30) Foreign Application Priority Data
Aug. 31, 2001 (DE) 10142433.7

(51) Int. Cl. A23L 1/00

(52) U.S. Cl. 99/275

(57) ABSTRACT

The invention relates to a beverage in which difructose dianhydride III is added as prebiotic dietary fibers, wherein the DFA III shows, even at a pH value of <3.9, sufficient storage stability during the entire shelf life of the beverage.

The present invention relates to a beverage with a storage-stable dietary fibre additive, preferably a dietary fibre with prebiotic properties, as well as its production.

Of interest here in particular are those dietary fibres which, because of their prebiotic properties, promote the growth of the advantageous bacteria in the intestine. An optimum intestinal flora can make an important contribution to health and the enhancement of well-being by strengthening the defence against diseases, stimulating the immune system or improving the absorption of particular nutrients, such as e.g. minerals.

For example, a preventative effect against intestinal cancer is ascribed e.g. to a fibre-rich diet.

The conventional diet today has however in general a low fibre content, so that a high-quality diet with a sufficient supply of fibre is in general not guaranteed.

In order nevertheless to ensure a sufficient supply of fibre, dietary fibres of all kinds are frequently added to foodstuffs today.

Thus it has been proposed to add to beverages, e.g. conventional refreshing beverages such as colas, lemonades, fruit drinks, soft drinks etc., soluble dietary fibres such as e.g. inulin. It has been found, however, that said soluble dietary fibres are not stable and decompose under hydrolysis at the low pH value of <3.9 which numerous beverages exhibit.

Due to the decomposition of said dietary fibres, however, the storage stability of said beverages in terms of the dietary fibres is reduced considerably and the dietary fibres no longer show their effect.

In order to ensure an adequate stability of the soluble dietary fibres in said beverages, the latter must exhibit a pH value of >4. Such an increase in the pH value of the beverages, however, has a severely negative effect on their taste.

A requirement therefore existed for a beverage with a preferably prebiotic dietary fibre additive, in which the dietary fibre additive in the beverage also does not decompose at a pH value of <3.9, in order thereby to enable an adequate storage stability of the beverage to be achieved.

To solve this problem, there is proposed in DE 199 53 727 a storage-stable beverage that contains inulin, in which the decomposition of the inulin is prevented by the fact that a part of the acid in the beverage is replaced by an acid-tasting surrogate. By said replacement of a part of the acid with an acid surrogate, the pH value of the beverage is adjusted to a value which is sufficiently high that the inulin does not decompose, but on the other hand the beverage remains acceptable in taste terms. By acid surrogates are understood here substances which confer an acid taste, but do not reduce the pH value on the scale that conventional fruit acids do.

DE 195 47 059 C2 describes a process for the enzymatic production of DFA III. It is pointed out there that DFA III is used both as a non-nutrient sweetener and for dietetic nourishment. There is no reference, however, to the addition of DFA III in particular to beverages with acid pH value.

In the light of the prior art described above, however, a beverage with dietary fibre additive would be desirable, in which the dietary fibre itself and hence the beverage exhibit an adequate storage stability, without changes in the fundamental character of the beverage, such as the pH value, having to be made.

Said problem is solved by a beverage that contains difructose dianhydride III as dietary fibre.

Difructose dianhydride III, abbreviated to DFA III, is α-D-fructofuranose-β-D-fructofuranose 1,2′: 2,3′-dianhydride.

DFA III is a soluble dietary fibre with prebiotic properties, with the advantageous effects mentioned above.

Surprisingly it was found that DFA III exhibits also for a pH value of <3.9 a high storage stability over the normal shelf life of beverages of 8-12 months. Even with a beverage pH value of substantially below pH 3.9, such as e.g. 2.5, a high storage stability was still ensured at a storage temperature of 25° C. over the entire normal shelf life of such beverages of some 8-12 months.

In general DFA III can be obtained by the enzymatic hydrolysis of inulin. For example, DFA III is obtained during the exposure of inulin-containing plant extracts to inulase II. In addition to inulin, fructooligosaccharides such as the following are also formed during the reaction: O-β-D-fructofuranosyl-(2→1)-O-β-fructofuranosyl-α-D-glucopyranoside (1-kestose, abbreviated to GF2), O-β-D-fructofuranosyl-[(2→1)-O-β-D-fructofuranosyl)]₂-α-D-glucopyranoside (nystose, abbreviated to GF3) and O-β-D-fructofuranosyl-[(2→1)-O-β-D-fructofuranosyl)]₃-α-D-glucopyranoside (fructosyl-nystose, abbreviated to GF4).

DFA III can be added to the corresponding beverage in any form, e.g. as dry matter, paste, syrup or in solution. The amount of DFA III that is added to the beverage is determined by the respective requirements and objectives. In general, however, the beverage according to the invention contains 0.01 to 25 wt %, preferably 0.25 to 2.5 wt %, of DFA III, referred to the weight of the beverage.

According to a further embodiment according to the invention the beverage according to the invention can contain, in addition to DFA III, oligosaccharides of the chain length 2-10, preferably 2-4.

In particular the fructooligosaccharides such as are obtained in addition to DFA III during the enzymatic decomposition of inulin can be involved here, examples of which have been listed above.

The oligosaccharides can be contained in the beverage according to the invention in an amount of not more than 25 wt %, preferably of less than 5 wt %.

According to a preferred embodiment the mixture of DFA III and oligosaccharides obtained during the enzymatic decomposition of inulin can be added to the beverage as dietary fibre directly, without prior isolation of the DFA III or the oligosaccharides.

The other components of the plant extract that are obtained during the enzymatic decomposition of inulin in addition to DFA III and the above-mentioned oligosaccharides can be separated for this according to conventional methods familiar to experts. It goes without saying that the oligosaccharide components are not limited to the representatives mentioned above by way of example, such as can be obtained during the enzymatic decomposition of inulin with inulase II, but that in principle any oligosaccharide obtained during such a decomposition can be contained in the mixture, or can be added to the beverage according to the invention as an oligosaccharide component in addition to DFA III.

Like DFA III, the filter oligosaccharides can also be added to the beverage in any form, either individually or in a mixture. For example, they can be added in dry form or together with a suitable solvent as a paste or solution in suitable viscosity, e.g. as syrup or in solution. A suitable solvent for adjusting the viscosity is e.g. water.

According to a preferred embodiment DFA III and optionally the oligosaccharides are added to the beverage in the form of a syrup.

The dry matter content of the syrup lies in this case in general between 55 and 75 wt %, preferably between 60 and 68 wt %, referred to the total weight of the syrup.

Said syrup can be added to the beverage in a proportion by weight of 0.05 to 15 wt %, preferably of 1 to 5 wt %, referred to the weight of the beverage.

The beverage can further also contain, in addition to DFA III and optionally the above-mentioned oligosaccharides with chain lengths of 2 to 10, other saccharides, e.g. glucose, fructose and saccharose and mixtures thereof.

An exemplifying mixture of DFA III and fructose-oligosaccharides can contain from 10 to 90 wt %, preferably 50 to 60 wt %, of DFA III, 0 to 20 wt %, preferably 4 to 8 wt %, of GF2, 0 to 50 wt %, preferably 12 to 23 wt %, of GF3 and G4, 0 to 10 wt %, preferably 0 to 1 wt %, of higher-chain oligosaccharides, 0 to 20 wt %, preferably 5 to 10 wt %, referred to the sum of saccharides, of saccharides selected from glucose, fructose and saccharose.

The beverages to which according to the invention DFA III is added as prebiotic dietary fibre can be any beverages. Examples of the latter are alcoholic or non-alcoholic beverages selected from coke, iced tea, lemonades, energy or sports drinks, fruit drinks, fruitjuices, beer, soft drinks, fruit-milk and yoghurt drinks, aromatized table or mineral water, mineral water and quinine-containing drinks.

The beverages can be present in any form, i.e. they can be present in the conventional liquid state or else in instant form, e.g. as an effervescent tablet, a powdery mixture for preparing the beverage, or else as concentrate.

The beverage can contain for this purpose conventional and suitable components and additives. There can also be added to the beverage, in addition to DFA III, further dietary fibres, in particular prebiotic dietary fibres such as inulin or galactooligosaccharides, vitamins or minerals.

Beverages enriched with a prebiotic dietary fibre can be obtained with the present invention, in which the dietary fibre also at a pH value of <3.9, in particular in a range of 2.5 to 3.9, exhibits an excellent storage stability and retains its prebiotic effect over the normal shelf life of the beverages of 8-12 months.

The present invention is naturally not limited to beverages with a pH value of <3.9; rather the addition according to the invention of DFA III as a prebiotic dietary fibre is suitable in principle also for application in beverages whose pH value is >3.9. Thus the pH value can lie in a range of 2.0 to 5.0, preferably 2.5 to 3.9, for the present invention.

1. Beverage containing dietary fibre,
characterised in that
the beverage contains difructose dianhydride III as storage-stable dietary fibre.

2. Beverage according to claim 1,
characterised in that
the beverage contains in addition oligosaccharides with a chain length of 2 to 10.

3. Beverage according to claim 1,
characterised in that
DFA III is contained in the beverage in a proportion of 0.01 wt % to 25 wt %.

4. Beverage according to claim 1,
characterised in that
the oligosaccharide is at least one selected from O-β-D-fructofuranosyl-(2→1)-O-β-fructofuranosyl-α-D-glucopyranoside (GF2), O-β-D-fructofuranosyl-[(2→1)-O-β-D-fructofuranosyl)]₂-α-D-glucopyranoside (GF3) and O-β-D-fructofuranosyl-[(2→1)-O-β-D-fructofuranosyl)]₃-α-D-glucopyranoside (GF4), higher-chain oligosaccharides, glucose, fructose and saccharose.

5. Beverage according to claim 1,
characterised in that
the oligosaccharide content in the beverage comes to not more than 25 wt %.

6. Beverage according to claim 1,
characterised in that
the beverage has a pH value that lies between 2.0 and 5.0.

7. Process for preparing a storage-stable beverage containing dietary fibre,
characterised in that
difructose dianhydride III is added to the beverage.

8. Process for preparing a beverage according to claim 7,
characterised in that
there is additionally added to the beverage at least one saccharide selected from GF2, GF3, GF4, higher-chain oligosaccharides, glucose, fructose and saccharose.

9. Process according to claim 7,
characterised in that
DFA III and/or the further saccharides are added to the beverage in the form of a syrup or as dry product.

10. Process for producing a beverage according claim 7,
characterised in that
DFA III or DFA III/oligosaccharide mixture is added to the beverage in an amount of 0.01 to 25 wt %, referred to the weight of the beverage.

11. Process for producing a beverage claim 7,
characterised in that
the DFA III/oligosaccharide mixture which is added is a composition with 10 to 90 wt % of DFA III, 0 to 20 wt % of GF2, 0 to 50 wt % of GF3 and/or GF4, 0 to 10 wt % of higher-chain oligosaccharides and 0 to 20 wt % of saccharides selected from glucose, fructose, saccharose and mixtures thereof.

12. Process according to claim 7,
characterised in that
there is added to the beverage at least one additive selected from prebiotic dietary fibres which are different from DFA III, non-prebiotic dietary fibres, vitamins and minerals.

13. Use of DFA III as a storage-stable dietary fibre in beverages.

14. Use according to claim 11,
characterised in that
drink has a pH value of 2.0 to 5.0.
